(19) United States
(12) Patent Application Publication
(10) Pub. No.: US 2015/0028991 A1
(43) Pub. Date: Jan. 29, 2015

(54) BIMETAL UNIT, TRIP UNIT, CIRCUIT BREAKER, SERIES OF CIRCUIT BREAKERS, AND METHOD FOR CALIBRATING CIRCUIT BREAKER

(71) Applicants: Rodrigo CHORA DE LA GARZA, Monterrey N.l. (MX); Ivan Alejandro GARCIA TOVAR, Monterrey N.L. (MX); Francisco Javier HURTADO MEZA, Monterrey N.L. (MX); Dariel TELLEZ TREVINO, Monterrey N. L. (MX)

(72) Inventors: Rodrigo CHORA DE LA GARZA, Monterrey N.l. (MX); Ivan Alejandro GARCIA TOVAR, Monterrey N.L. (MX); Francisco Javier HURTADO MEZA, Monterrey N.L. (MX); Dariel TELLEZ TREVINO, Monterrey N. L. (MX)

(73) Assignee: SIEMENS AKTIENGESELLSCHAFT, Munich (DE)

(21) Appl. No.: 14/189,069

(22) Filed: Feb. 25, 2014

(30) Foreign Application Priority Data
Jul. 26, 2013 (EP) 13178231.0

(51) Int. Cl. H01H 69/01; H01H 37/52

(52) U.S. Cl. CPC H01H 69/01; H01H 37/52
USPC 337/360

(57) ABSTRACT

A bimetal unit for a circuit breaker is disclosed, the bimetal unit including a bimetal element for releasing a trip mechanism of the circuit breaker. In an embodiment, the bimetal element is surrounded, in particular coaxially surrounded, by a ferrous ring and a copper coil wound around the ferrous ring. The ferrous ring and copper coil provide a compensation device which produces additional heat and, as a result, stronger bending to the bimetal element when a current flows through the same bimetal element. An embodiment of the invention is useful to employ bimetal element adapted for higher-rated current in a circuit breaker of lower-rated current as bimetal element exhibits similar bending behavior as in higher-rated circuit breaker. This enhances calibration and reduces manufacturing costs. A trip unit, a circuit breaker, a series of circuit breakers, and a method for calibrating a circuit breaker employing the bimetal unit, are also disclosed.

### PRIORITY STATEMENT

The present application hereby claims priority under 35 U.S.C. §119 to European patent application number EP 13178231.0 filed Jul. 26, 2013, the entire contents of which are hereby incorporated herein by reference.

### FIELD

At least one embodiment of the invention generally relates to a bimetal unit, a trip unit, a circuit breaker, a series of circuit breakers, and/or a method for calibrating a trip unit of a circuit breaker. In particular, at least one embodiment of the invention relates to a bimetal unit for a circuit breaker, a trip unit having the bimetal unit, a circuit breaker having the bimetal unit or the trip unit, a series of circuit breakers, and/or a method for calibrating a circuit breaker.

### BACKGROUND

A circuit breaker (or, in short, breaker) is known to be a device that is adapted to open and close a circuit by a nonautomatic device, and to open the circuit automatically on a predetermined overcurrent without damage to itself when properly applied within its rating. According to U.S. Pat. No. 6,135,633 A, a circuit breaker is known to have a trip mechanism having a bimetal element and a trip bar, the bimetal element being provided to move relatively to the trip bar in dependency of a current flow. Higher current differentially increases temperature in the bimetal element and causes a displacement towards the trip bar. Sufficiently high current causes trip bar actuation and circuit breaking.

It is known that for economical reasons, circuit breakers of different current rates share the same bimetal element. This is the case, for example, for one-pole breakers of the types ED41B015 and ED41B020, both manufactured and marketed by a subsidiary of the applicants. Both types, even though with different ratings, namely, 15 A and 20 A, respectively, use the same bimetal element marked as 20 A. The reason to share the same bimetal element is because the A bimetal element needs a special welding machine in order to comply with a good quality assembly in the breaker. Hence, the reasons to force the 15 A breaker to use the 20 A bimetal are:
to avoid having a separate welding line only for the 15 A breakers and,
the welding machine needed for the 15 A bimetal elements has a cost significantly greater than the ones used for the 20 A bimetal elements and the rest such as 50 A, 100 A, 125 A, etc.

In thermal calibration, an overcurrent of a predetermined overcurrent rate is flown through the bimetal element for a predetermined calibration time. For example, the overcurrent rate is often about 200% in relation to the rated current of the circuit breaker, and the calibration time is often about 60 seconds. It was found that with the above calibration parameters, the conforming rate (or calibration yield) for the circuit breakers is satisfying when the 20 A bimetal element is used in a 20 A circuit breaker. However, if the 20 A bimetal element was used in a 15 A circuit breaker, and the calibration was made using the afore calibration parameters (200% of 15 A, i.e., 30 A for about 60 seconds), and the breakers were re-tested to verify that their calibration falls within the acceptable time frame a less satisfying fraction of the production ended up conforming. This issue has been pinned on the bimetal element as the 20 A circuit breaker did not show the poor calibration performance seen on the 15 A circuit breaker. This is most likely because the 20 A breaker heats up more when exposed to the 200% calibration current (40 A) than the 15 A breaker when exposed to the 200% calibration current (30 A).

In order to increase the conforming rate (or calibration yield) for the 15 A breakers, the calibration rate was decreased from 200% (30 A) to 135% (20.25 A). The reduced overcurrent rate was compensated by a new calibration time that ws around 15 to 20 minutes, instead of the 60 seconds with the 200% nominal current used in the accelerated calibration. With the reduced calibration rate the bimetal element was heated up for a longer period allowing the breaker to improve the repeatability of the calibration. With this technique a significantly higher fraction of the production showed conforming results during the re-test of the calibration (made with the 135% of the nominal current).

The downside now, was on the amount of time spent for the thermal calibration of the 15 A breaker which can be up to 40 minutes in the best scenario. In contrast, a similar calibration yield of the 20 A breakers is achievable with the accelerated 200% overcurrent rate which allows it to have a breakers thermal calibrated in only 2 minutes in the best scenario. Thus, using 135% nominal current for calibration in the 15 A breakers is not an optimal solution for the calibration problems for this breaker, in terms of calibration time.

### SUMMARY

At least one embodiment of the present invention is directed to solving the aforesaid problems of calibrating a circuit breaker, at least partly. In particular, in embodiments of the present invention, a bimetal unit, a trip unit having the bimetal unit, a circuit breaker having the bimetal unit or the trip unit, a series of circuit breakers, and a method for calibrating a circuit breaker, are disclosed which overcome or at least improve upon at least one of the disadvantages of the afore-mentioned prior art and which allow using, in a circuit breaker, a bimetal element designed for a higher rated current than that of the circuit breaker, and still allowing calibration of the circuit breaker with similar or same calibration parameters and calibration yield as for a circuit breaker having the higher rated current.

A bimetal unit, a trip unit, a circuit breaker, a series of circuit breakers, and a method for thermally calibrating a circuit breaker are disclosed. Further features and details of the present invention result from the sub claims, the description and the drawings. Features and details discussed with respect to each aspect of embodiments of the invention can be applied to any other aspect of an embodiment of the invention.

At least one embodiment of the invention relies on the basic idea forming a first aspect of an embodiment of the invention where a bimetal unit for a circuit breaker includes a bimetal element which is surrounded, in particular coaxially surrounded, by a ferrous ring and a copper coil wound around the ferrous ring.

According to a further aspect of an embodiment of the invention, a trip unit for a circuit breaker includes a trip mechanism and a bimetal unit adapted to release the trip mechanism, wherein the bimetal unit is formed as described above. Such trip unit may be sold as a supply part and, if pre-mounted accordingly, is easy to install in a circuit breaker. As the trip unit of this aspect includes the bimetal unit of the embodiment of the first aspect, similar advantages may be achieved.

According to a further aspect of an embodiment of the invention, a circuit breaker has a bimetal unit including a bimetal element, wherein the bimetal element is mounted in the circuit breaker so that a current of the circuit breaker is flowable through the bimetal element. The bimetal unit is formed as described above. Of course, the bimetal unit may be integrated in a trip unit as described above. In the above arrangement, the bimetal element is directly heated. I.e., a current, in particular working current, of the circuit breaker flows through the bimetal element which is directly heated thereby. As the circuit breaker of an embodiment of this aspect includes the bimetal unit of an embodiment of the first aspect, similar advantages may be achieved.

According to a further aspect of an embodiment of the invention, a series of circuit breakers has circuit breakers of different types each having a directly heated bimetal element. The series includes a first type of circuit breaker designed for a first rated current and a second type of circuit breaker designed for a second rated current being higher than the first rated current, wherein the first type of circuit breaker and the second type of circuit breaker share a same type of bimetal element. According to an embodiment of this aspect of the invention, in the first type of circuit breaker the bimetal element is surrounded, in particular coaxially surrounded, by a ferrous ring and a copper coil wound around the ferrous ring, while in the second type of circuit breaker the bimetal element is not surrounded by a ferrous ring and a wound-around copper coil. Alternatively, in the second type of circuit breaker the bimetal element is surrounded, in particular coaxially surrounded, by a ferrous ring and a copper coil wound around the ferrous ring having a magnetic capacity and/or induction capacity lower than in the first type of circuit breaker. As in the series of circuit breakers at least one type includes the bimetal unit of the first aspect, similar advantages may be achieved. By the latter alternative, as different magnetic capacity and/or induction capacity results different heat generation upon current flow in the bimetal element, a higher-rated bimetal element may be used in circuit breakers of types of lower-rated current by more than one stage.

According to a further aspect of an embodiment of the invention, a method for thermally calibrating a circuit breaker having a bimetal unit including a directly heated bimetal element, is proposed including:

providing a ferrous ring and a copper coil wound around the ferrous ring, so that the ferrous ring with the wound-around copper coil surrounds, in particular coaxially surrounds, the bimetal element; and
sending electric current of a predetermined overcurrent rate through the bimetal element for a predetermined calibration time.

### BRIEF DESCRIPTION OF THE DRAWINGS

The present invention is further described with respect to the accompanying figures. The figures are schematic and include no limitation in terms of dimension or relative proportions of elements unless stated otherwise in the description.

FIG. 1 shows a bimetal unit according to an embodiment of the invention;

FIG. 2 shows a circuit breaker according to an embodiment of the invention;

FIG. 3 shows a series of circuit breakers according to an embodiment of the invention;

FIG. 4 is a flow diagram of a method of calibrating a circuit breaker according to an embodiment of the invention.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks will be stored in a machine or computer readable medium such as a storage medium or non-transitory computer readable medium. A processor(s) will perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments may be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

Note also that the software implemented aspects of the example embodiments may be typically encoded on some form of program storage medium or implemented over some type of transmission medium. The program storage medium (e.g., non-transitory storage medium) may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

At least one embodiment of the invention relies on the basic idea forming a first aspect of an embodiment of the invention where a bimetal unit for a circuit breaker includes a bimetal element which is surrounded, in particular coaxially surrounded, by a ferrous ring and a copper coil wound around the ferrous ring.

When current starts flowing through the bimetal element this will magnetize the ferrous ring and induce current in the copper coil. This induced current will be flowing in the copper coil and would create additional heat. The additional heat produces stronger bending of the bimetal element, as compared to the bending caused by the current flowing through the bimetal element alone. Therefore, the bimetal element would bend similarly with lower current (or stronger with same current). This additional bending can compensate for the use of a bimetal element of higher rated current in a circuit breaker of lower rated current.

In other words, the heat provided by the ferrous ring would cause a higher-rated (e.g., 20 A) bimetal element to deflect in the same manner as if it is used on an accordingly rated (i.e., e.g., 20 A) circuit breaker when in fact is being used on a lower-rated circuit breaker (e.g., 15 A). Thus, the ferrous ring and copper coil form a heating compensation device which will provide the performance needed for the calibration issues discussed above. As a result, the bimetal unit of this aspect of an embodiment of the invention can improve the calibration yield in the lower-rated circuit breaker when the higher-rated bimetal element is used and calibrated with calibration parameters appropriate with the rating of the circuit breaker. In particular, using the afore-mentioned solution would improve the performance of the 15 A breakers in two main areas:
Repeatability: Compensating for the heat that a 20 A breaker can generate would make the 15 A breaker to have the same repeatability as if it were actually a 20 A breaker.
Calibration Time: The 135% nominal current technique takes at least 40 minutes to thermal calibrate a 15 A breaker whereas with the magnetic heating compensation device could be done in at least 2 minutes (95% reduction of the current time spent in calibration).

It is preferable when the ferrous ring and copper coil are adapted as needed according to the breaker rating and bimetal rating. In other words, it would be advantageous if in the afore-described bimetal unit the ferrous ring and copper coil are designed to cooperatively produce, when a current lower than a rated current of the bimetal element is flown through the bimetal element, heat that results in a total deflection of the bimetal element which is similar to or the same as a deflection of the bimetal element when the rated current is flown therethrough in absence of the ferrous ring and copper coil. For example, the rated current of the bimetal element may be 20 A or about 20 A, and the current lower than the rated current may be 15 A or about 15 A, in order to address the specific problems mentioned in the context of the 15 A circuit breaker using a 20 A bimetal element. In particular, bimetal elements for rated currents lower than 20 A are to be manufactured with more expensive methods. Those methods can be avoided with the inventive bimetal unit by simply using the 20 A bimetal element having its heat capacity compensated by the ferrous ring and copper coil. Even if it might be conceivable that the copper coil is (additionally) provided with an active (external) current so as to produce additional heat, the structure and design is easier if the production of additional heat by the ferrous ring and copper coil is achieved passively by induced current only. In the afore context, a rated current is to be understood as a maximum continuous current an element is designed for, i.e., can carry without exceeding its rating. The rated current may also be addressed as current rating, ampere rating, or design threshold.

If in the aforementioned bimetal unit the bimetal element and the ferrous ring with the wound-around copper coil are pre-mounted to be installed within a casing of the circuit breaker at once, installation in the circuit breaker can be achieved more easily.

According to a further aspect of an embodiment of the invention, a trip unit for a circuit breaker includes a trip mechanism and a bimetal unit adapted to release the trip mechanism, wherein the bimetal unit is formed as described above. Such trip unit may be sold as a supply part and, if pre-mounted accordingly, is easy to install in a circuit breaker. As the trip unit of this aspect includes the bimetal unit of the embodiment of the first aspect, similar advantages may be achieved.

According to a further aspect of an embodiment of the invention, a circuit breaker has a bimetal unit including a bimetal element, wherein the bimetal element is mounted in the circuit breaker so that a current of the circuit breaker is flowable through the bimetal element. The bimetal unit is formed as described above. Of course, the bimetal unit may be integrated in a trip unit as described above. In the above arrangement, the bimetal element is directly heated. I.e., a current, in particular working current, of the circuit breaker flows through the bimetal element which is directly heated thereby. As the circuit breaker of an embodiment of this aspect includes the bimetal unit of an embodiment of the first aspect, similar advantages may be achieved.

In the circuit breaker of an embodiment of this aspect, the bimetal element may be of a type designed for a rated current higher than a rated current of the circuit breaker. In particular, the circuit breaker may be designed for an rated current of 15 A or about 15 A, and the bimetal element may further be of a type designed for a rated current of 20 A or about 20 A.

According to a further aspect of an embodiment of the invention, a series of circuit breakers has circuit breakers of different types each having a directly heated bimetal element. The series includes a first type of circuit breaker designed for a first rated current and a second type of circuit breaker designed for a second rated current being higher than the first rated current, wherein the first type of circuit breaker and the second type of circuit breaker share a same type of bimetal element. According to an embodiment of this aspect of the invention, in the first type of circuit breaker the bimetal element is surrounded, in particular coaxially surrounded, by a ferrous ring and a copper coil wound around the ferrous ring, while in the second type of circuit breaker the bimetal element is not surrounded by a ferrous ring and a wound-around copper coil. Alternatively, in the second type of circuit breaker the bimetal element is surrounded, in particular coaxially surrounded, by a ferrous ring and a copper coil wound around the ferrous ring having a magnetic capacity and/or induction capacity lower than in the first type of circuit breaker. As in the series of circuit breakers at least one type includes the bimetal unit of the first aspect, similar advantages may be achieved. By the latter alternative, as different magnetic capacity and/or induction capacity results different heat generation upon current flow in the bimetal element, a higher-rated bimetal element may be used in circuit breakers of types of lower-rated current by more than one stage.

In the series of circuit breakers the first rated current may be 15 A and the second rated current may be 20 A.

According to a further aspect of an embodiment of the invention, a method for thermally calibrating a circuit breaker having a bimetal unit including a directly heated bimetal element, is proposed including:

providing a ferrous ring and a copper coil wound around the ferrous ring, so that the ferrous ring with the wound-around copper coil surrounds, in particular coaxially surrounds, the bimetal element; and
sending electric current of a predetermined overcurrent rate through the bimetal element for a predetermined calibration time.

As in other words the method of an embodiment of this aspect makes use of the bimetal unit of the first aspect, similar advantages may be achieved. In this context, calibrating the circuit breaker can be understood as well as calibrating a trip unit, trip mechanism, bimetal unit, or bimetal element. The overcurrent rate is measured as a multiple (in %) of the rated current of the circuit breaker.

In the method of an embodiment of this aspect, the overcurrent rate may be more than 100%, preferable more than 150%, in particular 200% or around 200% of a rated current of the current breaker. The calibration time may be more than 30 seconds, preferably 55 seconds or more, and may additionally be less than 600 seconds, preferably less than 300 seconds, in particular 70 seconds or less.

The method, in an embodiment, is in particular applicable with the afore-described circuit breaker.

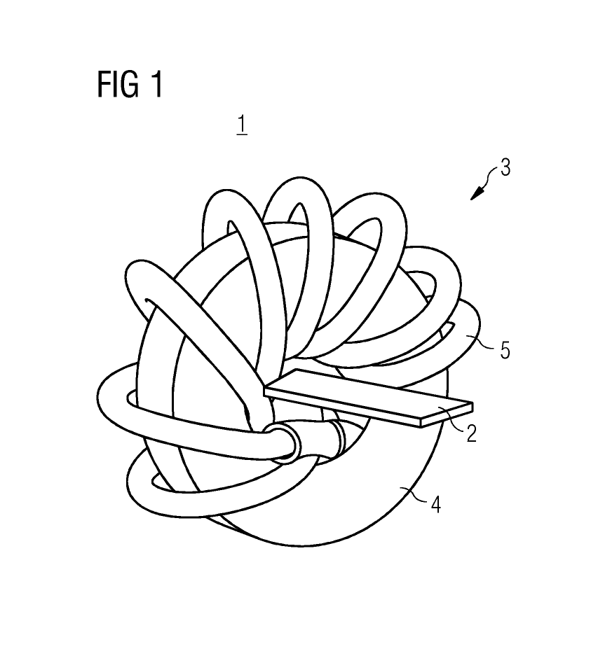

FIG. 1 schematically shows a perspective view of a bimetal unit 1 according to an embodiment of the invention. As shown in FIG. 1, the bimetal unit 1 includes a bimetal element 2 and a compensation device 3. The compensation device 3 includes a ferrous ring 4 and a copper coil 5 wound around the ferrous ring 4. The bimetal element 2 lies coaxially with a central axis of the ferrous ring 4. In other words, the bimetal element 2 is coaxially surrounded by the ferrous ring 4 with wound-around copper coil 5. Without limiting generality of the above, the bimetal element 2 is designed as to material, dimension and structure to be used in the trip unit of a circuit breaker rated for 20 A. As a specific example, the bimetal element 2 is designed to be used in the trip unit of a Sentron ED41B020 one-pole circuit breaker as available on the date of priority of this application.

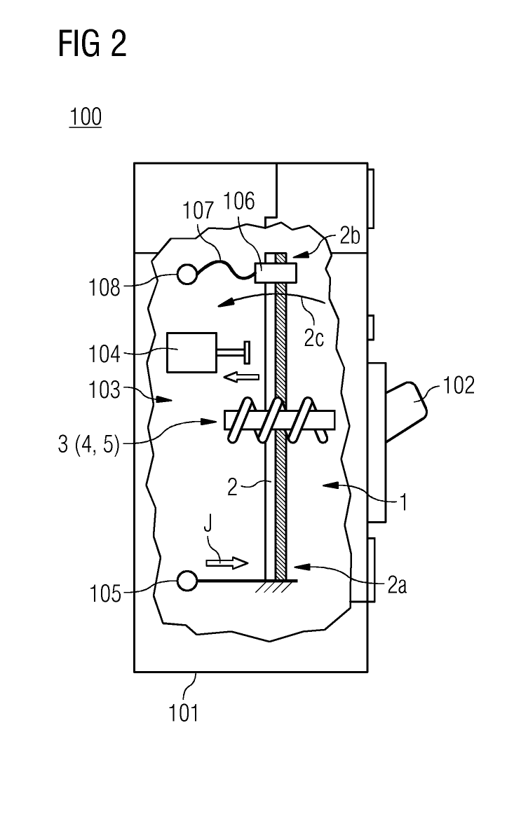

FIG. 2 schematically shows an elevational view of a circuit breaker 100 according to another embodiment of the invention. As shown in FIG. 2, the circuit breaker 100 includes a casing 101 and an operating handle 102 which is operable by an operator (not shown) from outside. Part of a front wall in the line of view of casing 101 is broken away so that an interior of circuit breaker 100 is visible. However, the representation of the interior of circuit breaker 100 is strictly schematic. Without limiting generality of the above and below, the circuit breaker 100 is rated for 15 A. As a specific example, the circuit breaker 100 is generally based on a Sentron ED41B015 one-pole circuit breaker as available on the date of priority of this application.

Circuit breaker 100 is a device that is adapted to open and close a circuit by a nonautomatic operating mechanism (not shown) which is operable by operating handle 102. In detail, upon moving operating handle 102 to an OFF position, main contacts (not shown) of circuit breaker 100 are opened while upon moving operating handle 102 to an ON position, the main contacts are closed. As is generally known, the operating mechanism includes a spring mechanism which provides for firmly snapping the main contacts in their respective opened or closed positions. Furthermore, circuit breaker 100 is adapted to open the circuit automatically by a trip unit 103 on a predetermined overcurrent without damage to itself when properly applied within its rating. Trip unit 103 includes a trip mechanism 104 and the bimetal unit 1 as shown in FIG. 1 (see relevant description above). When the main contacts of circuit breaker 100 are in a closed position, a biased lever (not shown) of the operating mechanism is locked by trip mechanism 104.

Referring to FIG. 2, bimetal element 2 of bimetal unit 1 has a fixed end 2a which is fixed in relation to casing 101 of circuit breaker 100, and a free end 2b which is movable according to a thermal strain inside the bimetal element 2. A bending direction 2c of bimetal element 2 is a direction to which bimetal element 2 bends upon growing temperature. The fixed end 2a of bimetal element 2 is connected to a fixed terminal 105 while the free end 2b of bimetal element 2 is connected, via a cuff 106 and a flexible line 107, to a terminal 108. A current J is applicable to bimetal element 2 through terminals 105, 108. Upon flowing current J, bimetal element 2 is directly heated by current and consequently bends in bending direction 2c towards trip mechanism 104. As soon as bimetal element 2 reaches trip mechanism 104, trip mechanism 104 releases the lever which provides for the operating mechanism to snap the main contacts into their opened position. As an initial distance between bimetal element 2 and trip mechanism 104 is adjusted so as to vanish upon a certain bending of bimetal element 2 according to a rated current of circuit breaker 100, trip unit 103 provides a thermal overcurrent protection of circuit breaker 100. As is generally known, trip mechanism 104 may also be released (tripped) manually by a release button (not shown) which works independently from the position of the operating handle 102 to provide for a safety device, or by an electromagnetic element (not shown) instantaneously responding to a short circuit current so as to provide a short circuit protection.

As further seen in FIG. 2, bimetal element 2 is surrounded by compensation device 3 including ferrous ring 4 with copper coil 5 wound around, as shown in FIG. 1. The compensation device 3 may be pre-mounted with the bimetal element 2 or may be independently fixed to casing 101 of circuit breaker 100. As easily understood from the description of FIG. 1 above, compensation device 3 adds further heat to the bimetal element 2 when a current J runs through the bimetal element 2 so that trip mechanism 104 is earlier reached by bimetal element 2 compared with a circuit breaker 100 having no such compensation device 3.

As, in this embodiment, bimetal element 2 is designed for a rated current (20 A) higher than the rated current (15 A) of circuit breaker 100 is used, compensation device 3 may make the bimetal element 2 behave as if included in a circuit breaker of the higher rated current (20 A). Thereby, employing and calibrating the circuit breaker 100 may be easier and more reliable.

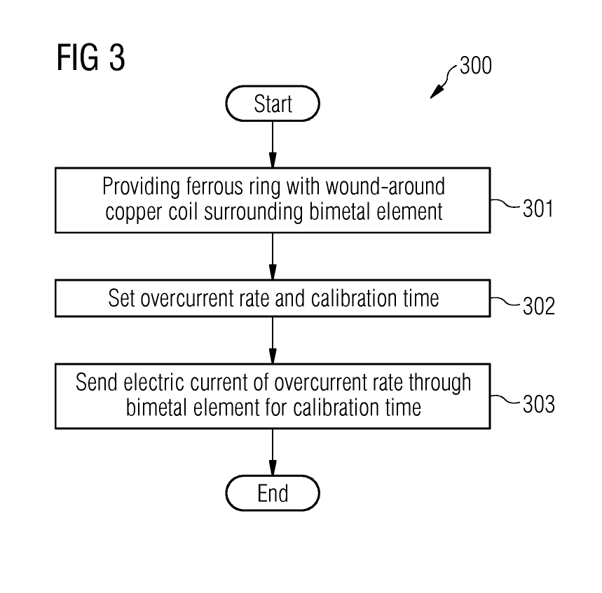

FIG. 3 is a flow diagram showing a calibration process 300 of circuit breaker 100 of FIG. 2.

Upon start of process 300, a ferrous ring and a copper coil wound around the ferrous ring are provided so that the ferrous ring with the wound-around copper coil surrounds, in particular coaxially surrounds, the bimetal element, in step 301. In other words, circuit breaker 100 of FIG. 2 is prepared and set up.

After that, a predetermined overcurrent rate and a predetermined calibration time are set in step 302. For example, a calibration device (not shown) is connected to circuit breaker 100 (FIG. 2) and prepared to run a calibration cycle with the aforementioned parameters. For example, the overcurrent rate is set to 200% of the rated current of circuit breaker 100, and the calibration time is set to 60 seconds. In adapted processes, calibration parameters may be varied as needed. E.g., the overcurrent rate may be lowered to 150% or even somewhat above 100%, e.g. 135%, of the rated current, and the calibration time may be reduced to somewhat above 30 seconds, or extended up to 300 or even 600 seconds, depending on circumstances. For a 15 A breaker employing a 20 A bimetal element, an overcurrent rate of 200% (30 A) for a calibration time of 55 to 70 seconds has been found to be an optimum.

Then, an electric current of previously set predetermined overcurrent rate is sent through the bimetal element for the previously set predetermined calibration time, in step 303.

After that, the process 300 ends.

Even if not shown in the Figure, a step of verifying the calibration of the circuit breaker may be applied.

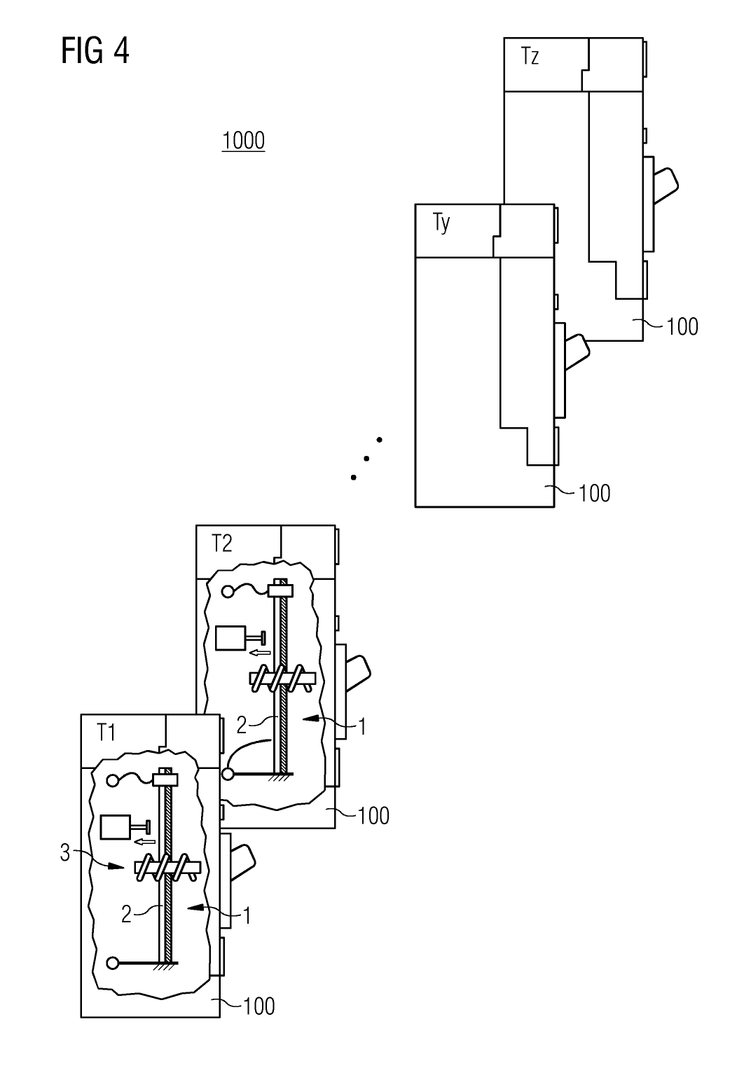

FIG. 4 is a schematic depiction of a series 1000 of circuit breakers 100. Series 1000 includes a plurality of types T1, T2, . . . , Ty, Tz of circuit breakers 100 each being defined by its rated current. For example, circuit breakers 100 of a first type T1 are designed and adapted for a rated current of 15 A, circuit breakers 100 of a second type T2 are designed and adapted for a rated current of 20 A, circuit breakers 100 of a penultimate type Ty are designed and adapted for a rated current of 110 A, and circuit breakers 100 of a last type Tz are designed and adapted for a rated current of 125 A. Such scaling may be found, e.g., in the Sentron ED41Bxxx series of the applicants. However applicability of the invention is not limited thereto.

As shown in FIG. 4, each type of circuit breaker 100 is equipped with a bimetal unit 1 having a bimetal element 2. However, while in the first type T1 the bimetal unit 1 has the compensation device 3 (see FIG. 1), the second type T2 and further types do not have the compensation device.

It is, however, conceivable that a further type (not shown) of circuit breaker of the same series is designed and adapted for a rated current of 10 A and has a compensation device 3 of enhanced magnetic capacity as compared with compensation device 3 of circuit breaker 100 of type T1. With this, an even stronger heat addition may be produced so that not only the 15 A breaker 100 (T1) but also a 10 A breaker may exhibit similar bending behavior of bimetal element 2 as the 20 A breaker 100 (T2) with even more reduced current flow according to a 10 A rating.

It is also conceivable that, besides types T1 and T2, other pairs or groups of circuit breaker types of the series 1000 may share the bimetal element of the highest-rated type of the respective pair or group of circuit breaker types.

### REFERENCE SIGNS, UNITS, AND SYMBOLS

1 bimetal unit
2 bimetal element
2a fixed end
2b free end
2c bending direction
3 compensation device
4 ferrous ring
5 copper coil
100 circuit breaker
101 casing
102 operating handle
103 trip unit
104 trip mechanism
105 terminal
106 cuff
107 flexible line
108 terminal
300 calibration process
301-303 process steps
1000 series of circuit breakers
A Ampere(s)
J current
T1 first type of circuit breakers
T2 second type of circuit breakers

What is claimed is:

1. A bimetal unit for a circuit breaker, comprising:
a bimetal element, the bimetal element being surrounded by a ferrous ring, a copper coil being wound around the ferrous ring.

2. The bimetal unit of claim 1, wherein the ferrous ring and copper coil are designed to cooperatively and passively produce, when a current lower than a rated current of the bimetal element is flown through the bimetal element, heat that results in a total deflection of the bimetal element which is similar to or the same as a deflection of the bimetal element when the rated current of the bimetal element is flown therethrough in absence of the ferrous ring and copper coil.

3. The bimetal unit of claim 1, wherein the bimetal element and the ferrous ring with the wound-around copper coil are pre-mounted to be installed together within a casing of the circuit breaker.

4. A trip unit for a circuit breaker, the trip unit comprising:
a trip mechanism; and
the bimetal unit of claim 1, adapted to release the trip mechanism.

5. A circuit breaker, comprising:
the bimetal unit of claim 1 including a bimetal element, the bimetal element being mounted in the circuit breaker such that a current of the circuit breaker is flowable through the bimetal element.

6. The circuit breaker of claim 5, wherein the bimetal element is of a type designed for a rated current higher than a rated current of the circuit breaker, wherein the circuit breaker is designed for an rated current of 15 A or about 15 A, and wherein the bimetal element is further of a type designed for a rated current of 20 A or about 20 A.

7. A series of circuit breakers, each including a directly heated bimetal element, the series of circuit breakers including a first type of circuit breaker designed for a first rated current and a second type of circuit breaker designed for a second rated current being relatively higher than the first rated current, wherein the first type of circuit breaker and the second type of circuit breaker share a common type of bimetal element, wherein in the first type of circuit breaker, the bimetal element is surrounded by a ferrous ring and a copper coil, the copper coil being wound around the ferrous ring, and wherein in the second type of circuit breaker, the bimetal element is not surrounded by a ferrous ring and a wound-around copper coil, or is surrounded by a ferrous ring and a copper coil wound around the ferrous ring having at least one of a magnetic capacity and induction capacity relatively lower than in the first type of circuit breaker.

8. The series of circuit breakers of claim 7, wherein the first rated current is 15 A and the second rated current is 20 A.

9. A method for thermally calibrating a circuit breaker having a bimetal unit including a directly heated bimetal element, the method comprising:
providing a ferrous ring and a copper coil wound around the ferrous ring such that the ferrous ring with the wound-around copper coil surrounds the bimetal element; and
sending electric current of an overcurrent rate through the bimetal element for a calibration time.

10. The method of claim 9, wherein the overcurrent rate is more than 100% of a rated current of the circuit breaker.

11. The method of claim 9, wherein the calibration time is more than 30 seconds.

12. The method of claim 12, wherein the calibration time is 55 seconds or more.

13. The method of claim 9, wherein the bimetal element is of a type designed for a rated current higher than a rated current of the circuit breaker, wherein the circuit breaker is designed for an rated current of 15 A or about 15 A, and wherein the bimetal element is further of a type designed for a rated current of 20 A or about 20 A.

14. The bimetal unit of claim 1, wherein the bimetal element is coaxially surrounded by the ferrous ring.

15. The bimetal unit of claim 2, wherein the rated current of the bimetal element is 20 A or about 20 A, and current lower than the rated current of the bimetal element is 15 A or about 15 A.

16. The bimetal unit of claim 2, wherein the bimetal element and the ferrous ring with the wound-around copper coil are pre-mounted to be installed together within a casing of the circuit breaker.

17. A trip unit for a circuit breaker, the trip unit comprising:
a trip mechanism; and
the bimetal unit of claim 2, adapted to release the trip mechanism.

18. A circuit breaker, comprising:
the bimetal unit of claim 2 including a bimetal element, the bimetal element being mounted in the circuit breaker such that a current of the circuit breaker is flowable through the bimetal element.

19. The method of claim 9, wherein the bimetal element is coaxially surrounded by the ferrous ring.

20. The method of claim 10, wherein the overcurrent rate is more than 150 of a rated current of the circuit breaker.

21. The method of claim 20, wherein the overcurrent rate is 200% or around 200% of a rated current of the circuit breaker.
